(19) United States
(12) Patent Application Publication
(10) Pub. No.: US 2017/0053226 A1
(43) Pub. Date: Feb. 23, 2017

(54) Staff exchange matching method and system

(71) Applicant: DANNA GIANFORTE, SUNNYVALE, CA (US)

(72) Inventor: DANNA GIANFORTE, SUNNYVALE, CA (US)

(73) Assignee: SWAPABILITY INC, SUNNYVALE, CA (US)

(21) Appl. No.: 14/833,017

(22) Filed: Aug. 21, 2015

(51) Int. Cl. G06Q 10/06

(52) U.S. Cl. CPC G06Q 10/063112

(57) ABSTRACT

The invention is a staff augmentation exchange matching system and method that provides sophisticated, automated matching to present relevant staff augmentation exchange opportunities to managers (users). The matching algorithms create either direct or multi-point matches. The automated matching is determined by matching the staff skills of one manager to the project needs of other managers resulting in a clearly defined opportunity for a staff augmentation engagement. Managers then use the system to contact each other to initiate a staff augmentation exchange engagement based on the matches presented.

### CROSS-REFERENCES TO RELATED APPLICATIONS (IF ANY)

None

### BACKGROUND

1. Field of the Invention

The present invention relates to a data processing system for an automated staff exchange matching method and system.

2. Description of Prior Art

The proper assignment and utilization of staff in an organization is one of the toughest challenges for a manager. Often, a manager has either a limited or resource constrained skill set for a project, or set of projects, but does not have the budget for or long term need for additional resources with the skill set required for the most optimal project outcome.

This predicament is continually repeated within a single or multiple organizations, without limitation to organizational focus or geographical location. With organizations trying to accomplish the most with the minimal amount of staffing required, a limited expertise and/or resource constrained workforce presents managers with unique challenges to meet their goals. Managers currently share their staffing predicaments with other managers within their professional networks through communication channels such as relevant conferences, presentations and/or email lists without any systematic, automated means of finding suitable staff exchange opportunities.

This was evidenced at the Higher Education User Group Alliance Conference presentation in March 2010 when three universities from Canada, Australia and New Zealand described how they randomly met each other at a conference and decided to share staff with each other for approximately three months in order to assist each other with important projects. This was done without an automated system which impeded the exchange by requiring additional management overhead and limited the opportunity to just those schools who randomly connected with each other at a conference. An automated system available for use by others would both provide a consolidated place to find a variety of opportunities open for anyone as well as save resource effort by providing a more efficient, automated matching process.

The need for an automated method for matching the staff skills of one manager with the project needs of another manager provides an opportunity for a more optimally exploited workforce by assigning and exchanging personnel in a manner that provides the largest mutual benefit to both organizations.

### SUMMARY OF THE INVENTION

The present invention relates to an automated staff exchange matching system and method. This system and method provides sophisticated, automated matching to present relevant staff augmentation exchange opportunities to managers. The matching algorithms create either direct or multi-point matches. The automated matching is determined by matching the skills of one manager's staff to the project needs of other managers resulting in a clearly defined opportunity for a staff augmentation engagement. Managers then contact each other to initiate a staff augmentation exchange engagement based on the matches presented and trade augmentation agreement details based on formal outcome expectations.

The process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system; and

FIG. 2 shows a Diagram of a Direct Match; and

FIG. 3 shows a Diagram of a Multi-Point Match.

### DESCRIPTION OF THE PREFERRED EMBODIMENT

There are a number of significant design features and improvements incorporated within the invention.

The present invention relates to a data processing system 101 which is an automated staff exchange matching system and method that invokesa sophisticated matching algorithm to present relevant staff augmentation exchange opportunities to managers. The matching algorithms create either direct or multi-point matches. The automated matching is determined by matching the skills of one manager's staff to the project needs of other managers resulting in a clearly defined opportunity for a staff augmentation engagement.

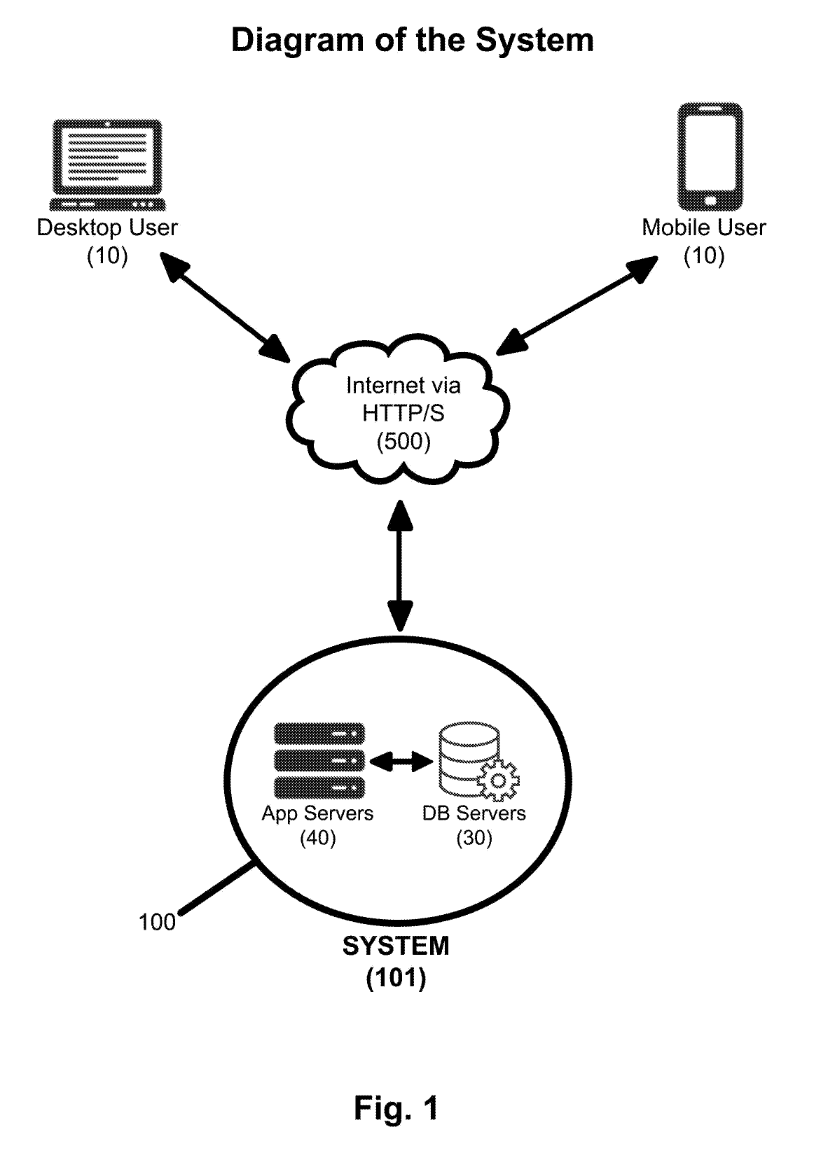

FIG. 1 displays the preferred embodiment of the system architecture 101 accessed through an Internet, Intranet and/or Wireless network 500. However, the system could be implemented on a client/server architecture as well. Most typically, users of the system 101 are managers within their organization. However, users of the system 101 are not required to be managers.

In FIG. 1, the system 101 is accessed from a user's computing device 10 through a web browser over HTTP and/or HTTPS protocols 500. A computing device 10 that can access the system 101 must have some version of a CPU, CPU memory, local hard disk, keyboard and display unit. A printer or multiple printers may also be included but are not required. The computing device 10 can be any desktop, laptop, tablet, smart phone or general purpose computing device with an appropriate amount of memory suitable for this purpose and an active connection to the Internet 500. Computing devices like this are well known in the art and are not pertinent to the invention.

The system 101 software and database reside in the system's local server architecture 100. The system 101 operates on one or more application servers 40 that (a) process user requests from the web browser and (b) run the matching algorithms. The system 101 uses one or more memory means such as a standard hard drive or any other standard memory device to process the user requests and matching algorithms. User data and staff augmentation matches found by the system algorithms are stored in one or more databases on one or more database servers (30). The databases 30 are stored in the system memory means and the platform 101 changes the system's memory as it operates. The system can be written in a number of different programming languages and run on a number of different operating systems, database formats and platforms.

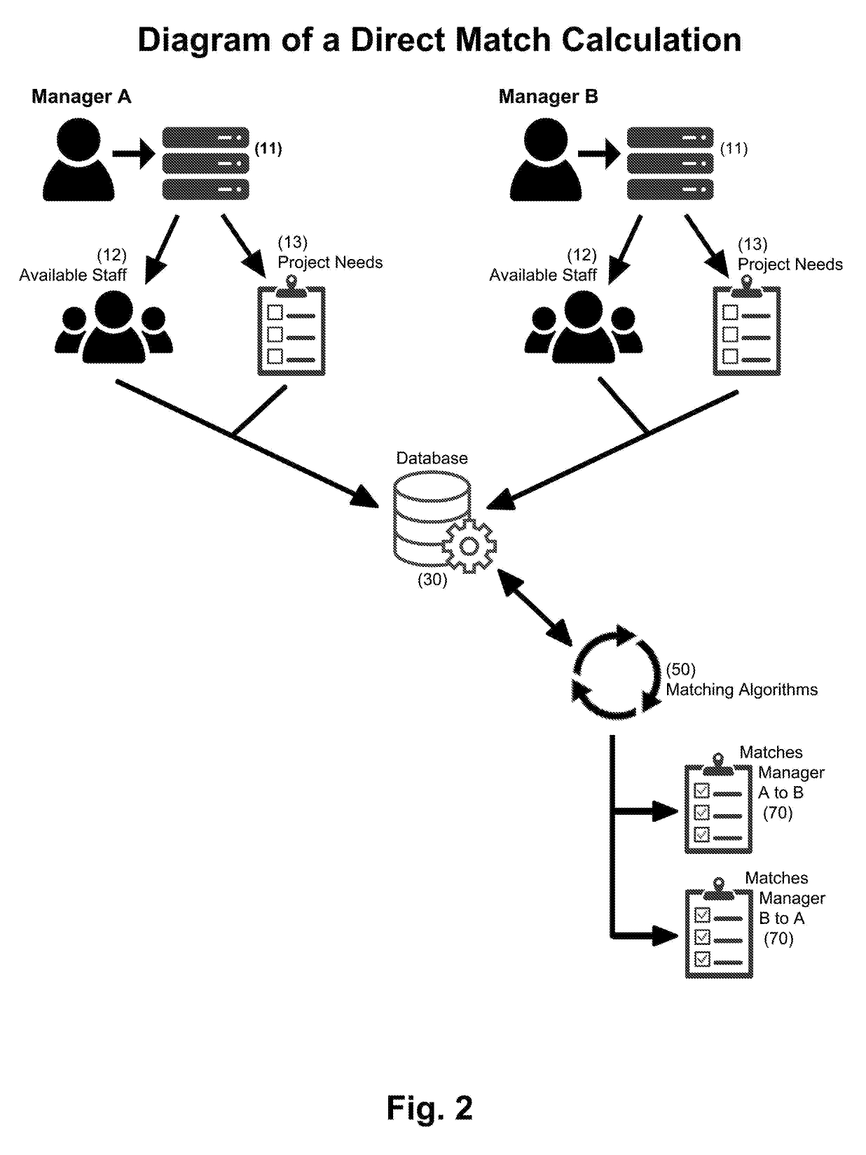

The system 101 is a system that calculates direct or multi-point matches. A direct match is between one manager and another whereby each manager has staff skills available and project needs fulfilled by the other. A multi-point match is created when staff of three or more managers are required in order to provide a mutually beneficial staff exchange for every manager involved in the match. The intent of the system 101 is to bring different organizations together for a mutually beneficial staff augmentation exchange arrangement. However, the matches could be found within a single organization as well. FIG. 2 shows a diagram of a direct match between two managers (users). In this situation, Manager A creates an account 11 on the system 101. Manager A saves a list of his/her staff 12 and indicates their skills available for an exchange. Manager A saves a list of projects 13 and indicates a list of skills that the projects require. Manager B also creates an account 11. Manager B saves a list of his/her staff 12 and indicates their skills available for an exchange. Manager B saves a list of projects 13 and indicates a list of skills that the projects require. Both sets of projects 13 and available staff 12 are saved into the database 30 and related to the appropriate manager user account 11. The system uses matching algorithms 50 that find a direct match between Manager A and Manager B such that staff skills available and project skills needed are fulfilled by the one-to-one direct match. The system then presents possible staff exchange opportunities to each manager.

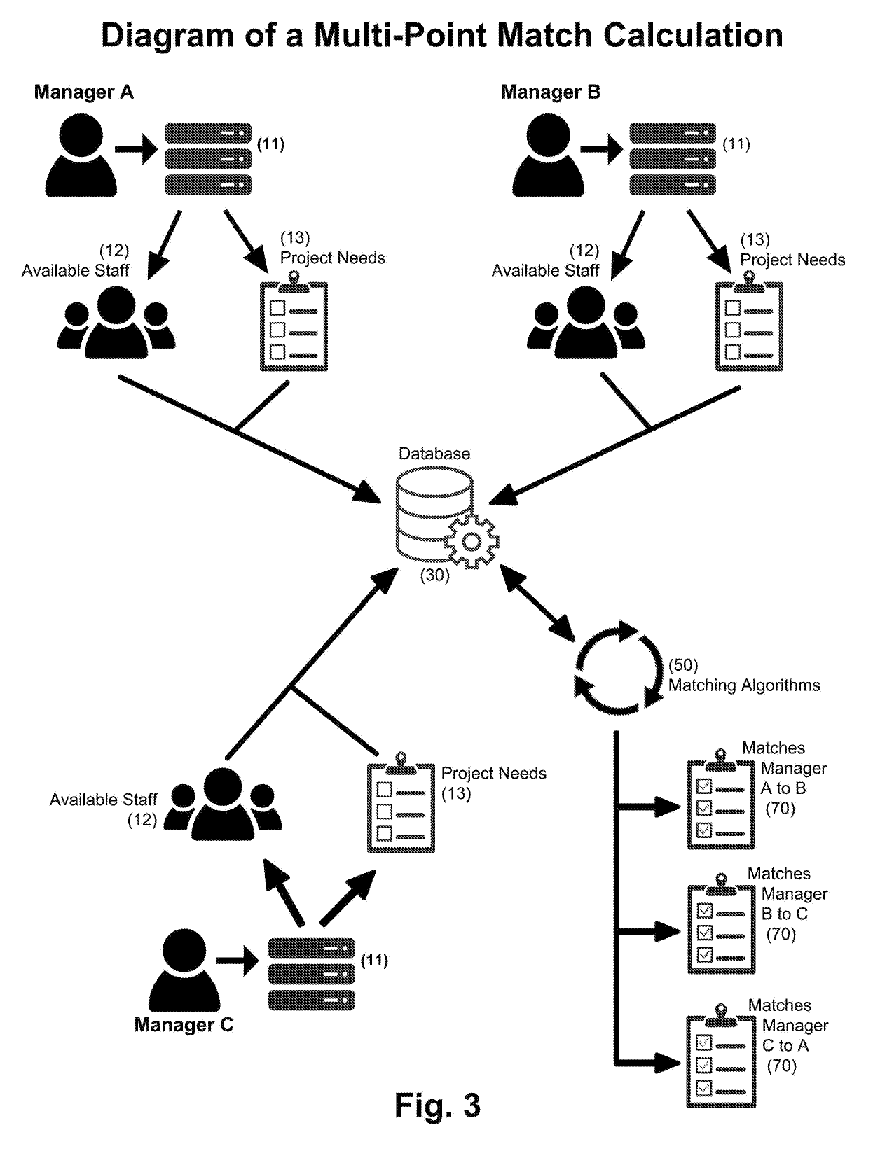

FIG. 3 displays a diagram of a multi-point match. This is similar to the direct match but requires three or more managers (users) to be connected such that each manager involved both (a) has staff skills available that match another manager's projects and (b) has project needs met by a different manager in the connection. Again, a multi-point match occurs when a direct match is not possible to ensure each manager is presented with a mutually beneficial scenario—they all have staff available and project needs met by another. In this situation, Manager A creates an account 11. Manager A saves a list of staff 12 and indicates their skills available for an exchange. Manager A saves a list of projects 13 and indicates a list of skills the projects require. Manager B also creates an account 11. Manager B saves a list of staff 12 and indicates their skills available for an exchange. Manager B saves a list of projects 13 and indicates a list of skills the projects require. Manager C also creates an account 11. Manager C saves a list of staff 12 and indicates their skills available for an exchange. Manager C saves a list of projects 13 and indicates a list of skills the projects require.

All records for all manager users 11 are saved into the database 30 and related to the appropriate manager user account 11.

The system 101 uses matching algorithms 50 that find a multi-point match between three or more managers such that each manager involved both (a) has staff skills available that match another manager's projects and (b) has project needs met by another manager in the connection. Again, a multi-point match occurs when a direct match is not possible to ensure each manager is presented with a mutually beneficial scenario—they both have staff available and project needs met by another.

The system 101 then presents possible staff exchange opportunities 70 to each manager 11 in the form of direct or multi-point matches for each project need 13 the manager has a related staff skill match. This can be repeated for as many managers (users) that have created staff profiles 12 and projects 13 they would like assistance with in the form of a staff augmentation exchange.

The system 101 allows managers to then contact each other through the system to initiate a staff augmentation exchange engagement based on the matches 70 presented and trade augmentation agreement details based on formal outcome expectations.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method:
having a system for staff exchanges that resides in the electronic memory of a computing server;
having two or more users where the users are managers;
having the users being from one or more different organizations;
having a usersaving staff and their related skills and a list of projects with related skills the projects require onto a database;
using automated matching algorithms to match one user's staff skills available with the project skill needs of another;
displaying the staff augmentation opportunities to each user; and
providing an electronic means for the users to contact each other.

2. A method according to claim 1 in having a plurality of users.

3. (canceled)

4. A method according to claim 1 where the system matches projects and skills directly between exactly two users.

5. A method according to claim 1 where the system matches projects and skills through multi-point matches of at least three different users.

6. A method according to claim 1 where the system matches first matches skills directly and if there is no match then the skills are matched through multi-point matches.

7. A method according to claim 1 where the user creates an account.

8. A method according to claim 1 where multi-point matches are created when staff of three or more users provide a staff exchange for every manager involved in the match.

9. A method:
having a system for staff exchanges that resides in the electronic memory of a computing server;
having two or more users where the users are managers;
having the users being from two or more different organizations;
having a usersaving staff and their related skills and a list of projects with related skills the projects require onto a database;
using automated matching algorithms to match one user's staff skills available with the project skill needs of another;
displaying the staff augmentation opportunities to each user; and
providing an electronic means for the users to contact each other.
